(19) United States
(12) Patent Application Publication
(10) Pub. No.: US 2017/0190381 A1
(43) Pub. Date: Jul. 6, 2017

(54) Ring and Grove Stabilized Twist Release Magnetic Attachment System

(71) Applicant: Clifford J. Casey, Bellevue, WA (US)

(72) Inventor: Clifford J. Casey, Bellevue, WA (US)

(21) Appl. No.: 14/984,689

(22) Filed: Dec. 30, 2015

(51) Int. Cl. B62M 3/08

(52) U.S. Cl. CPC B62M 3/086

(57) ABSTRACT

The current invention discloses a magnetic attachment system for securing force to hold the shoe to the pedal. The current invention, MagneRing Attachment System, is comprised of components: Magnetic Attachment; Stabilizing Ring; Twist Release facilitated by the placement of the magnets. The magnets are affixed to the pedal and to the cleat and the edges of the pedal are modified in order to provide a groove, which interlocks with a raised ring on the edge of the cleat providing for horizontal stabilization. The Magnetic Attachment has a pedal having 6 cylindrical cavities to hold the 6 magnets in place and cleat having 5 cylindrical cavities to hold the 5 magnets in place. The Stabilizing Ring has a groove around the cleat and a raised ring on the pedal. The Twist Release is achieved by twisting the heel of the foot to the outside.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The invention relates to the application of the MagneRing Attachment Technology to the MagnePull Pedal/Cleat System, an improved clip-less pedal magnetic attachment system improving performance over the existing pedal systems.

(2) Background of Invention

Cycling has evolved as sport and has come a long way in terms of improvements and new inventions.

Traditionally, the cyclist has to start riding first and then has to strap tighten the strap, or toe-clip. This makes the movement of cyclist difficult while dis-engaging his shoe from pedal and therefore was inconvenient. This system is only effective for experienced cyclists in appropriate conditions. The use of toe-clips also had a number of serious disadvantages. Most serious of these were the inability of the rider to disengage his feet from the pedals in case of an unexpected or emergency stop. This became especially serious with the increase in popularity of mountain bikes. Mountain bikes are most often used in off-road conditions. This type of riding is often far less predictable than more traditional cycling. As a result, unexpected or emergency stops are far more common and the riders of mountain bikes have a much greater need to be able to rapidly separate themselves from their bicycles. Hence, there arises a need for better bicycle pedal systems, this lead to the development of a number of different clips-less pedal systems.

Clip-less pedals (also known as clip-in or step-in system) requires a special cycling shoe with a shoe piece fitted to the sole, which locks into a mechanism in the pedal and thus holds the shoe firmly to the pedal. Most clip-less pedals lock onto the shoe piece when stepped on firmly and unlock when the heel is twisted outward, although in some cases the locking mechanism is built into the cleat instead of the pedal. Clip-less refers to the toe clip (cage) having been replaced by a locking mechanism and not to platform pedals which would normally not have toe clips. The clip-less pedal was invented by Charles Hanson in 1895. It allowed the rider to twist the shoe to lock and unlock and had rotational float (the freedom to rotate the shoe slightly to prevent joint strain). The M71 was a clip-less pedal designed by Cino Cinelli and produced by his company in 1971. It used a plastic shoe shoe-piece, which slid into grooves in the pedal and locked in place with a small lever located on the backside of the pedal body. To release the shoe a rider had to reach down and operate the lever, similar to the way a racing cyclist had to reach down and loosen the toe strap. The lever was placed on the outside edge of the pedal so that in the event of a fall the lever hitting the ground would release the foot. The shoe piece is engaged by simply pushing down and forward on the pedal, or, with some designs, by twisting the shoe piece in sideways. Then, instead of loosening a toe strap or pulling a lever, the cyclist releases a foot from the pedal by twisting the heel outward.

The next major development in clip-less pedals was Shimano's SPD (Shimano Pedaling Dynamics) pedal system. SPD shoe pieces are small and could be fitted in a recess in the sole, making it possible to walk (although comfort will vary, as the soles of different cycling shoes vary in their rigidity depending on design). Cycling shoes have rigid soles to maximize power transfer and efficiency. They may be specific to road or mountain biking, or usable for both. Shoes designed for mountain biking typically have recessed shoe pieces that do not protrude beyond the sole of the shoe, and have treads for walking on trails, as walking or carrying the bike is often required. Road cycling shoes are typically lighter than their mountain bike counterparts, and feature a protruding shoe piece and less weather proofing. The protruding shoe piece makes these shoes impractical for walking, as doing so can damage the shoe piece. Mountain bike shoe pieces can generally be mounted without difficulty to road shoes although sometimes an adapter is required. Such attachment is not usually possible for road pedals, as the shoe pieces are normally too large to be mounted on mountain shoes. The smaller mountain bike shoe pieces are attached to the sole of the shoe by two bolts; larger road-specific shoe pieces are attached by three. Various manufacturers have produced their own designs of clip-less pedal systems over the years.

The current invention discloses an advanced clip-less system having a twist release technology in the disclosed magnetic attachment system consisting of magnets placed in cavities made inside the pedal and cleat. The current invention is easy to detach from pedal by using twist release magnetic attachment technology.

### SUMMARY OF THE INVENTION

In an illustrative embodiment, the MagnePull Pedal/Cleat system is provided, consisting of a pedal that has cavities, wherein the magnets a securely placed, these magnets creates a magnetic field that magnetically attracts and holds via the magnets securely placed in the cleat on to the shoe to near proximity. This magnetic force provides stability when the shoe cleat is on the pedal.

The object of the current invention is to provide a bicycle pedal and cleat that provides a good grip to the cyclist shoe.

It is also an object of the invention to provide an improved magnetic attachment system that binds the shoe to pedal.

It is also an object of the invention to provide a magnetic attachment system that is easy to use.

It is further an object of the invention to provide a magnetic attachment system that is suitable for wide variety of bi-cycles.

Other objectives of the invention will become apparent to those skilled in the art once the invention has been shown and described. These objectives are not to be construed as limitations of applicant's invention, but are merely aimed to suggest some of the many benefits that may be realized by the apparatus of the present application and with its many embodiments. In addition to the various objects and advantages of the present invention described with some degree of specificity above it should be obvious that additional objects and advantages of the present invention will become more readily apparent to those persons who are skilled in the relevant art from the following more detailed description of the invention.

### BRIEF DESCRIPTION OF THE DRAWINGS

In In addition to novel features and advantages mentioned above, other objects and advantages of present invention will be readily apparent from the following descriptions of the drawings and exemplary embodiments, wherein like reference numerals across the several views refer to identical or equivalent features. To provide better understanding of the advantages and features of the present invention, the following detailed drawings are provided. It should be understood that these drawings depict typical embodiments, and are not intended to be limiting in scope.

FIG. 1: isometric view of MagneRing Attachment Technology testing plates.

FIG. 2: isometric view MagneRing Attachment Technology testing plates.

FIG. 3: isometric view of pedal base—MagnePull Pedal/Cleat System.

FIG. 3(b): is illustration of pedal sub assembly—MagnePull Pedal/Cleat System.

FIG. 4: isometric view of cleat—MagnePull Pedal/Cleat System.

FIG. 4(b): is illustration of cleat sub assembly—MagnePull Pedal/Cleat System.

FIG. 5: is illustration of pedal and cleat assembly—MagnePull Pedal/Cleat System.

FIG. 6: isometric view of pedal spindle—MagnePull Pedal/Cleat System.

### DETAIL DESCRIPTION OF THE INVENTION

At the outset it is noted that although the invention is described in multiple various exemplary embodiments and implementations in this document, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any exemplary embodiments described or shown herein.

In this embodiment, the MagnePull Pedal/Cleat System, using MagneRing Attachment Technology, provides a unique pedal and cleat that may be used to provide fixation of the cyclist's shoe to the pedal, while at the same time, may allow the cyclist to release from the pedal.

The attachment force of the magnetic binding system can be customized to fit the rider's needs or experience by changing the thickness or number of the magnets. The variation of the grade and type of magnet can affect the attraction force as well.

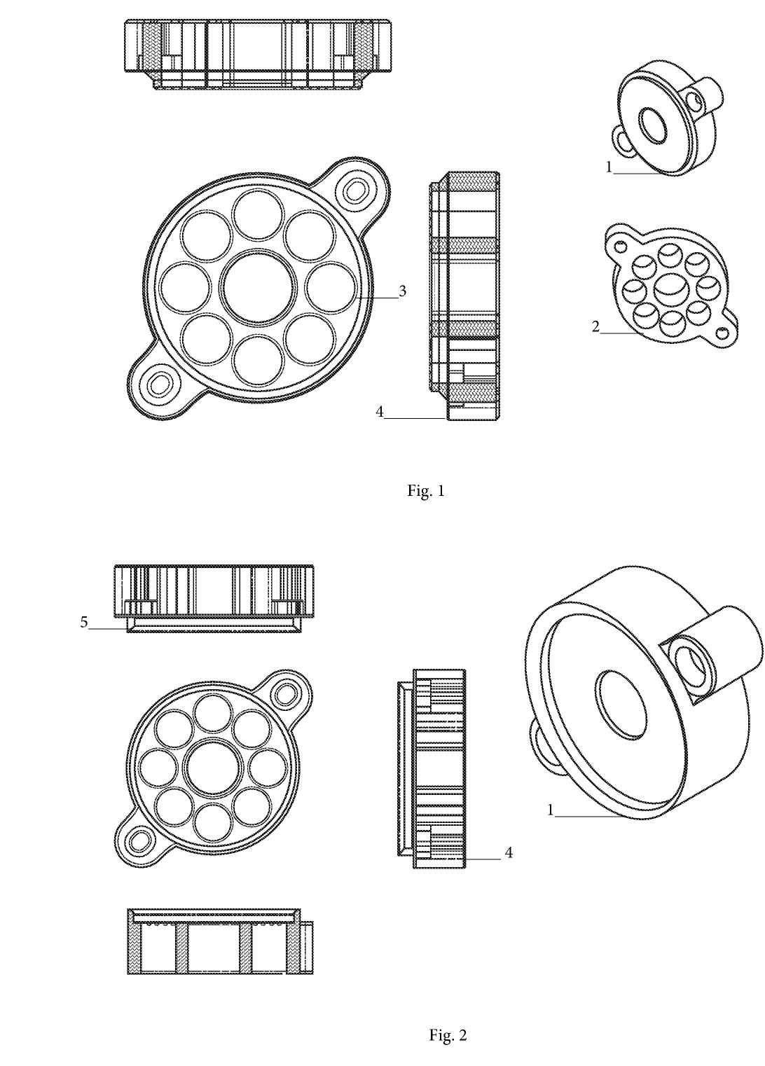

The current invention discloses a magnetic attachment system for securing force to hold the shoe to the pedal. The perspective view of testing base used for fabrication of system embodiments are illustrated in FIG. 1.

The current invention, MagneRing Attachment System, is comprised of 3 components:

1) Magnetic Attachment 1

2) Stabilizing Ring 2

3) Twist Release facilitated by the placement of the magnets 3

As can be inferred from FIG. 1 and FIG. 2 which disclose the three components of the MagneRing Attachment System, magnets 3 are affixed to the pedal 4 and to the cleat 5. The edges of the pedal are modified in order to provide a raised ring which interlocks with a groove on the edge of the cleat 5 providing for horizontal stabilization.

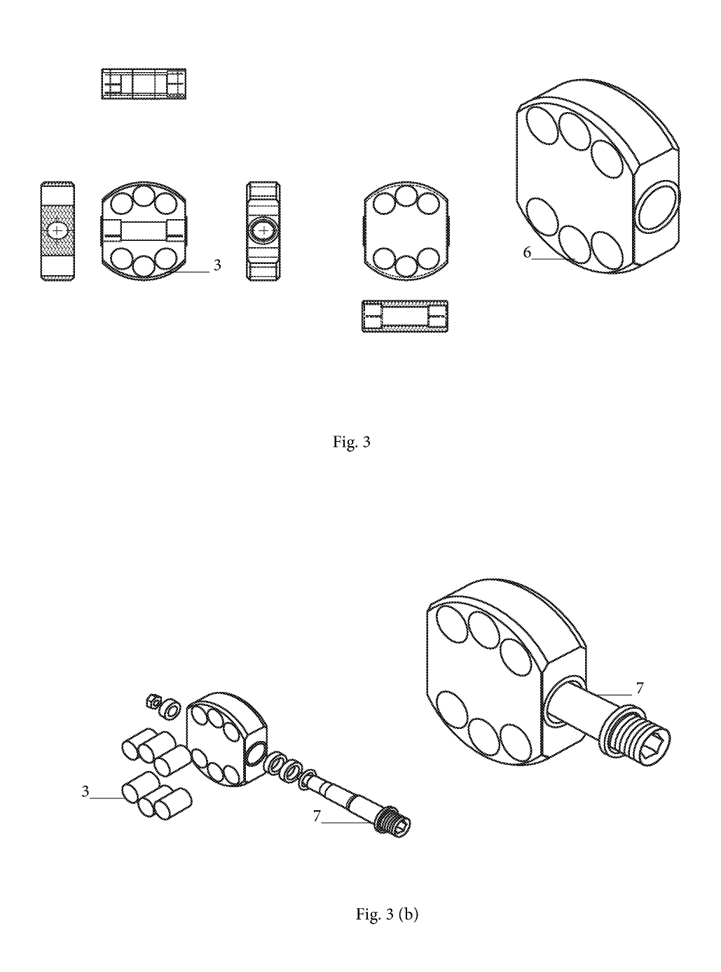

With reference to FIG. 3, the pedal sub assembly comprised of pedal base, with six cylindrical holes 6 for magnets 3, mounted to the threaded spindle 7 with bearing and nuts. Further FIG. 3 and FIG. 3(b) refer to schematic representation and sectional view of pedal sub assembly wherein the pedal base containing threaded spindle 7 is fitted with the cylindrical magnets 3.

Further, the platform of pedal portion has a circular shape, truncated on both the inner and outer side, 1.92 inches in width and having total thickness of 1.01 inches.

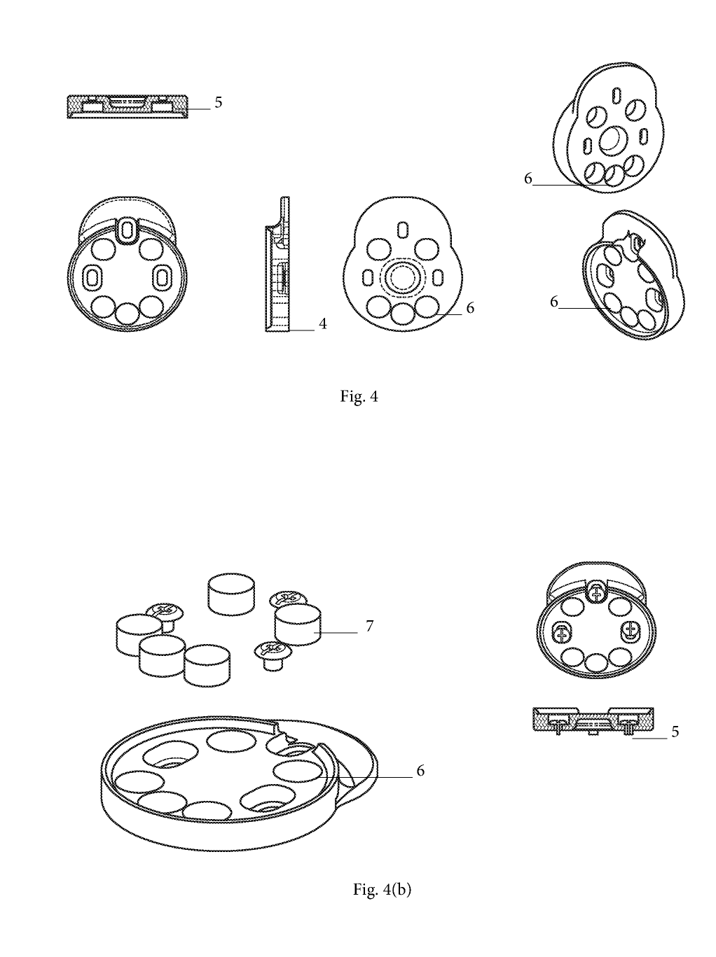

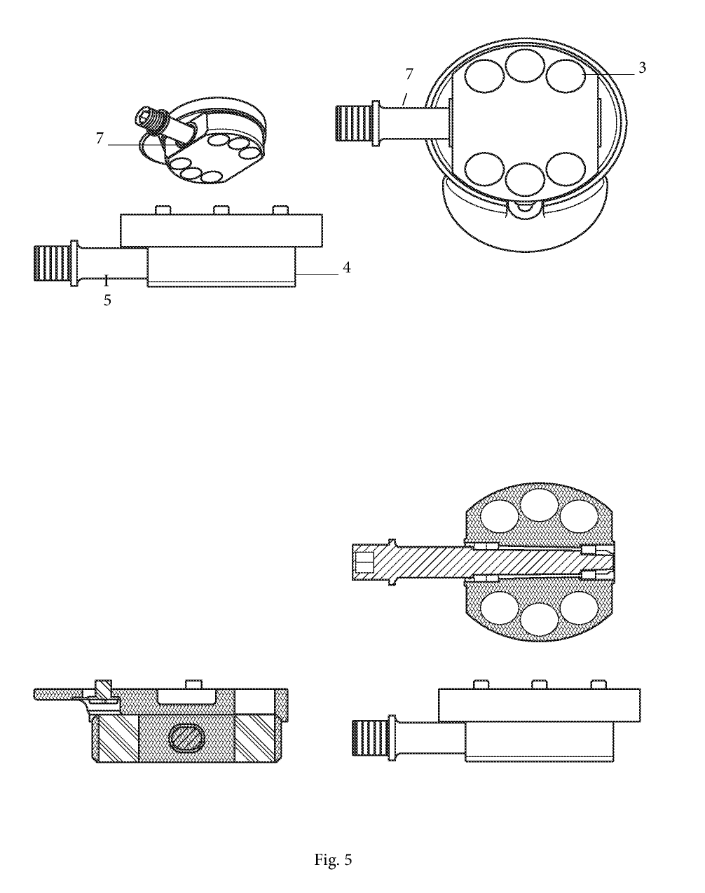

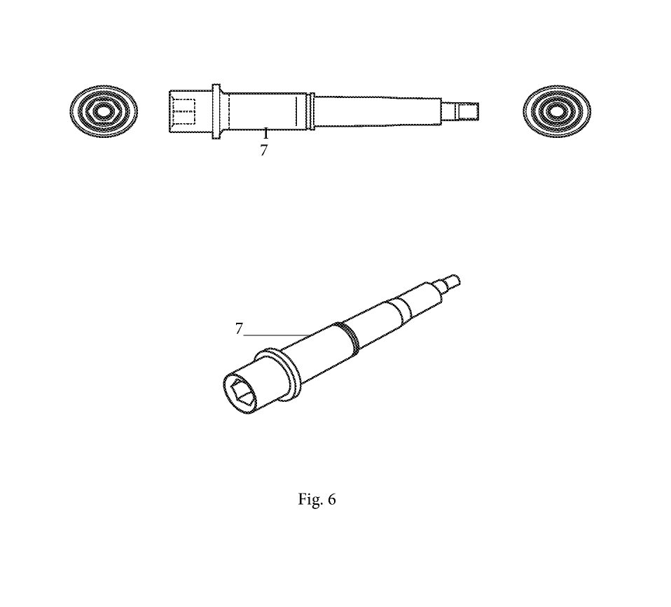

The cleat 5 used in current invention has a traditional three slot bolt hole configuration for attachment to the sole of the shoe. The cleat assembly is 3.26 inches in length, 2.695 inches in width and is 0.380 inches thick. FIG. 4 and FIG. 4(b) illustrate the cleat 5 and cleat sub assembly. Also shown in the figures is the cylindrical hole 6 for magnets 3 with the pedal 4. FIG. 5 also illustrates different 3-D views of the cleat 5 and pedal assemblies representing the cleat attachment with the pedal 4, along with the threaded spindle 7 and the magnets 3. In a preferred embodiment, the present invention is provided to secure the rider's biking shoe to the bicycle pedals 4 wherein the MagnePull Pedal/Cleat System uses magnets 3 as the securing force in comparison to the existing technology, which uses springs, clamps or other mechanical components as the securing force.

In the placement of the cleat onto the pedal as shown in FIG. 5, the arrangement of the magnets 3 provides a strong attachment force when aligned. When the magnets 3 are twisted or rotated the attach force will be replaced by a repel force and makes the release of cleat 5 from pedal easy. The magnetic attachment system including a cleat 5 attached to a rider's shoe with magnets 3 placed strategically at the critical engagement points, and a pedal including a pedal body having the magnets 3 placed strategically at the critical engagement points on the pedal 4.

As mentioned earlier, FIG. 4 and FIG. 4(b) illustrated different view of the cleat 5 and cleat sub assembly. These cleats 5 are affixed to the bottom of cycling shoes. The current invention, MagnePull Pedal/Cleat System, provides the rider with a secure connection to the pedal 4, and still allows the rider to rapidly disengage in the event of an unexpected stop.

With reference to sectional view in FIG. 6, the current invention comprised of a standard titanium spindle 7 (part of the pedal) having traditional threading and is 3.375 inches in length, tapering 0.5 inches to 0.25 inches in diameter.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Although the invention has been explained in relation to its preferred embodiment, it is to be understood that many other possible modifications and variations can be made without departing from the spirit and scope of the invention.

It is to be understood that the above description is intended to be illustrative, and not restrictive.

I/We claim:

1. A magnetic attachment system, comprising:
4. Magnetic Attachment
iii. A pedal having 6 cylindrical cavities to hold the 6 magnets in place.
iv. A cleat having 5 cylindrical cavities to hold the 5 magnets in place.
5. Stabilizing ring
i. A groove around the cleat
ii. A raised ring on the pedal
6. Twist Release
i. By twisting the heel of the foot to the outside.
